(19) United States
(12) Patent Application Publication
(10) Pub. No.: US 2021/0071063 A1
(43) Pub. Date: Mar. 11, 2021

(54) EFFECT OF PARTICLE SIZE ON THE HYDRAULIC CONDUCTIVITY OF GEOTHERMAL GROUT SYSTEMS

(71) Applicant: HALLIBURTON ENERGY SERVICES, INC., Houston, TX (US)

(72) Inventor: Shantel STONE, Conroe, TX (US)

(21) Appl. No.: 16/957,483

(22) PCT Filed: Aug. 24, 2018
(86) PCT No.: PCT/US2018/047887

§ 371 Date: Jun. 24, 2020

Related U.S. Application Data
(60) Provisional application No. 62/641,700, filed on Mar. 12, 2018.

(51) Int. Cl. C09K 8/467; C04B 28/00; C04B 14/02; E21B 33/14

(52) U.S. Cl. CPC C09K 8/467; C04B 28/001; C04B 2201/32; E21B 33/14; C04B 14/024

(57) ABSTRACT

Grout fluids, methods of preparing the grout fluids, and methods of using the grout fluids are provided. The methods of preparing the grout fluids include providing a thermally conductive material in a plurality of particle sizes, formulating a grout fluid including each particle size of the plurality of particle sizes of the thermally conductive material, determining permeability for each formulated grout fluid, identifying a particle size range of the thermally conductive material that provides a permeability of less than 1×10⁻⁷ cm/s as measured by ASTM procedure D5084, and preparing a grout fluid including the thermally conductive material having the identified particle size range.

### CROSS-REFERENCE TO RELATED APPLICATIONS

This application claims priority to U.S. Provisional Application No. 62/641,700 filed Mar. 12, 2018, entitled “Effect of Particle Size on the Hydraulic Conductivity of Geothermal Grout Systems,” the disclosure of which is hereby incorporated by reference in its entirety.

### BACKGROUND

The present disclosure relates generally to grout fluids, to methods of preparing the grout fluids, and to methods of using the grout fluids in geothermal grout systems. In particular, the present disclosure relates to determining the effect of particle size on hydraulic conductivity (or permeability) of a grout fluid. The geothermal industry requires a grout that achieves a permeability at or below 1×10⁻⁷ cm/s.

Grouting is the process of placing an effective seal in a hole. The sealing agents used are generally known as grouts. To be effective, they must be easy to put in place and must have low permeability to limit the migration of contaminants to the subsurface.

Historically, the geothermal industry used sand as a thermally conductive material in geothermal grouts, which showed little variation in particle size between sand sources. As the industry shifts to other thermally conductive material such as graphite and metal shavings, the particle size of these materials can vary.

Thus, there is a continuing need for improved grout fluids and methods for determining how to maintain permeability of a grout fluid.

### BRIEF DESCRIPTION OF THE DRAWINGS

The following figures are included to illustrate certain aspects of the present invention, and should not be viewed as an exclusive embodiment. The subject matter disclosed is capable of considerable modification, alteration, and equivalents in form and function, as will occur to those of ordinary skill in the art and having the benefit of this disclosure.

FIG. 1 illustrates a schematic of a system configured to deliver a grout fluid of the present disclosure to a downhole location for grouting a geothermal well loop, according to one or more embodiments;

FIG. 2 depicts a method of preparing a grout fluid according to one or more embodiments;

FIG. 3 depicts another method of preparing a grout fluid according to one or more embodiments;

FIG. 4 depicts a method of preparing a grout fluid according to one or more embodiments;

FIG. 5 illustrates the results of permeability testing on grout fluids according to one or more embodiments; and

FIG. 6 illustrates additional results of permeability testing on grout fluids according to one or more embodiments.

### DETAILED DESCRIPTION

Understanding the impact of particle size on permeability facilitates the optimization of thermally conductive components within a particle size range of the grout. The data provided herein shows that there is a limitation for the particle size of thermally conductive materials, independent of loading concentration, which negatively impacts permeability. In general, the larger the particle size of the thermally conductive material, the worse the permeability, and the smaller the particle size of the thermally conductive material, the better the permeability. Identifying a particle size range that positively impacts, or has no significant impact, on permeability facilitates control of the particle size range for thermally conductive materials. By “positively impact” is meant that permeability is lowered. By “significant” is meant a variation of about 10% or less. By “particle size” is meant the diameter or volume of a particle.

The grout fluid generally includes an aqueous fluid and a grout. The aqueous fluid utilized in the grout fluid can be water from any source provided that it does not adversely affect the components or properties of the grout fluid and contaminate nearby soil. The aqueous fluid generally includes fresh water, hard water, soft water, deionized water, mineral water (to a certain extent it does not contain heavy minerals), and any combination thereof. In one or more embodiments, the aqueous fluid is fresh water. In one or more embodiments, fresh water in an amount sufficient to form a pumpable fluid is mixed with the grout.

The grout generally includes a clay material. The clay material may include bentonite. As used herein, “bentonite” refers to an absorbent aluminum phyllosilicate clay. In one or more embodiments, the bentonite includes montmorillonite. The bentonite may include elemental bentonite, e.g., potassium bentonite, sodium bentonite, calcium bentonite, aluminum bentonite and combinations thereof. As used herein, “elemental bentonite” refers to a bentonite having the named element, e.g., potassium etc. as the dominant (majority) element therein. In one or more embodiments, the bentonite includes sodium bentonite. The grout may include the bentonite in an amount in a range of from about 50 weight percent to about 90 weight percent, from about 55 weight percent to about 80 weight percent, or from about 60 weight percent to about 70 weight percent, based on the total weight of the grout, for example.

As used herein, “bentonite-based grout” refers to a grout having at least 60 percent by weight bentonite based on the total weight of the grout. For example, a bentonite-based grout may include at least about 65 weight percent bentonite, at least about 70 weight percent bentonite, or at least about 75 weight percent bentonite, based on the total weight of the grout. As used herein, “grout” refers to the total solids content present in the grout fluid.

In one or more embodiments, the grout fluid includes a thermally conductive material. Such materials include those materials known to those of ordinary skill in the art to be thermally conductive. Suitable thermally conductive materials may include, but are not limited to, silicates such as sand, quartz silica, and combinations thereof, carbon-based materials such as graphite (e.g., flaked graphite), carbon nanotubes, graphene, pitch coke, tar coke, amorphous carbon, vein carbon, powdered carbon, desulfurized petroleum coke, carbon steel, and combinations thereof, and metal particulates such as brass, a brass alloy, chrome nickel steel, stainless steel, a transition metal (e.g., copper, cadmium, cobalt, gold, silver, iridium, iron, molybdenum, nickel, platinum, and/or zinc), a transition metal alloy (e.g., alloys of copper, cadmium, cobalt, gold, silver, iridium, iron, molybdenum, nickel, platinum, and/or zinc), a post-transition metal (e.g., lead or tin), a post-transition metal alloy (e.g., alloys of lead and/or tin), an alkaline earth metal alloy (e.g., alloys of beryllium and/or magnesium), and combinations thereof. In one more embodiments, the thermally conductive material includes a carbon-based material such as graphite. In one or more embodiments, the graphite includes a flaked graphite. The grout fluid may include the thermally conductive material in an amount in a range of from about 1 weight percent to about 75 weight percent, or from about 5 weight percent to about 70 weight percent, or from about 10 weight percent to about 65 weight percent, based on the total weight of the grout fluid, for example.

The grout or grout fluid may include one or more additives. For example, the additives may be dry blended into the grout, or the additives may be added directly to the grout fluid. The additives may be selected from consistency modifiers, grout setting modifiers, and combinations thereof.

In one or more embodiments, the consistency modifiers include inert fillers, permeability reduction additives, and combinations thereof. In one or more embodiments, the consistency modifier can be any inert particulate material, such as powdered graphite, natural pozzolans, fly ash, diatomaceous earth, powdered silica materials (e.g., silica flour), talc, kaolin, illite, dolomite, mineral fillers (e.g., sand), rock, stone, perlite particles, vermiculite, water inert powders such as calcium carbonate and barium sulfate, sepiolite, zeolite, fuller's earth, calcium bentonite, and combinations thereof. In one or more embodiments, the consistency modifier is selected from inert fillers such as calcium carbonate, silica flour, powdered graphite, and combinations thereof. In one or more embodiments, the consistency modifier can be a permeability reduction additive such as polyanionic cellulose, carboxymethyl starch, modified lignins, and combinations thereof. In one or more embodiments, the consistency modifier includes calcium carbonate, silica flour, powdered graphite, and combinations thereof. The grout may include the consistency modifier in an amount in a range of from about 1 weight percent to about 50 weight percent, from about 20 weight percent to about 45 weight percent, or from about 30 weight percent to about 40 weight percent, based on the total weight of the grout, for example. The grout fluid may include the consistency modifier in an amount in a range of from about 0.5 weight percent to about 15 weight percent, from about 2 weight percent to about 10 weight percent, or from about 4 weight percent to about 7 weight percent, based on the total weight of the grout fluid, for example.

The grout-setting modifier, among other things, may control the rheology of the grout and stabilize the grout over a broad density range. In one or more embodiments, grout-setting modifiers include inhibitors, dispersants, and combinations thereof. Inhibitors allow the grout fluid to remain workable until full hydration of the bentonite occurs. In one or more embodiments, suitable inhibitors include a salt comprising a cation and an anion, a polymer, a silicate (e.g., potassium silicate), a partially hydrolyzed polyvinyl acetate, a polyacrylamide, a partially hydrolyzed polyacrylamide, a polyalkylene glycol (e.g., polybutylene glycol, polyethylene glycol, and/or polypropylene glycol), a polyalkylene alcohol, a polyalkylene alkoxylate, a polyalkylene oligomer, a polyalkylene polymer, a polyalkylene copolymer, a cationic oligomer or polymer, an acid, a potassium salt (e.g., potassium fluoride, potassium chloride, potassium chlorate, potassium bromide, potassium iodide, potassium iodate, potassium acetate, potassium citrate, potassium formate, potassium nitrate, tribasic potassium phosphate, potassium phosphate dibasic, potassium phosphate monobasic, potassium sulfate, potassium bisulfate, potassium carbonate, potassium dichromate, and/or potassium ferrate), an ammonium salt (e.g., ammonium sulfate), a sodium salt (e.g., sodium chloride), an iron salt, an aluminum salt, a phosphonium salt, polyaminopolyamide-epichlorohydrin resin, diallydimethylammonium chloride, polydiallyldimethylammonium chloride, aminoethylethanolamine, diethylenetriamine, triethylenetetramine, diethanolamine, triethanolamine, polyvinyl pyrrolidone, and any combination thereof. In one or more embodiments, the inhibitors include ammonium sulfate, potassium chloride, sodium chloride, partially hydrolyzed polyacrylamide, and combinations thereof.

Dispersants break up or scatter particles of bentonite, which allows the grout fluid to remain workable until hydration and set. In one or more embodiments, suitable dispersants include ammonium lignosulfonate salt, metal lignosulfonate salts, phosphates, polyphosphates, organophosphates, phosphonates, tannins, leonardite, polyacrylates having a molecular weight less than about 10,000, and combinations thereof. In one or more embodiments, the dispersant includes sodium acid pyrophosphate (SAPP), AQUA-CLEAR® PFD DRY dispersant (commercially available from Halliburton Energy Services, Inc.), and combinations thereof.

In one or more embodiments, suitable grout-setting modifiers include ammonium sulfate, potassium chloride, sodium chloride, SAPP, partially hydrolyzed polyacrylamide, and combinations thereof. The grout may include the grout-setting modifier in an amount in a range of from about 0.1 weight percent to about 5 weight percent, from about 0.3 weight percent to about 4 weight percent, or from about 0.5 weight percent to about 2 weight percent, based on the total weight of the grout, for example. The grout fluid may include the grout-setting modifier in an amount in a range of from about 0.01 weight percent to about 5 weight percent, from about 0.05 weight percent to about 3 weight percent, or from about 0.1 weight percent to about 1 weight percent, based on the total weight of the grout fluid, for example.

In one or more embodiments, the grout is used in conjunction with a typical 50 pound grout system. In one or more embodiments, the grout is used in conjunction with a reduced concentration grout system. For example, the concentration of the grout is reduced so that it is about 15 pounds of grout per about 11.5 gallons of water, about 15 pounds of grout per about 27 gallons of water, about 25 pounds of grout per about 11.5 gallons of water, or about 25 pounds of grout per about 27 gallons of water, including all the values in between these concentrations. In one or more embodiments, the grout concentration is reduced to about 25 pounds of grout per about 14 gallons of water, or about 25 pounds of grout per about 20 gallons of water, including all the values in between these concentrations. In one or more embodiments, the grout concentration is about 0.5 pounds of grout per gallon of water to about 2.2 pounds of grout per gallon of water. In one or more embodiments, the concentration of grout is reduced to about 50 pounds of grout per about 30 to about 50 gallons of water, or about 1 pound of grout per gallon of water to about 1.7 pounds of grout per gallon of water.

In one or more embodiments, the grout and/or grout fluid may include further additives as deemed appropriate by one of ordinary skill in the art. Suitable additives would bring about desired results without adversely affecting other components in the grout or grout fluid, or the properties thereof.

The grout fluid is generally formed via methods known in the art. For example, the grout fluid may be formed by contacting or mixing the grout, the aqueous solution, and the one or more additives. The grout may be made by combining all of the components in any order and thoroughly mixing or blending the components in a manner known to one of ordinary skill in the art. An aqueous solution and the grout may then be mixed to form the grout fluid using a standard mixing device such as a grouter or other similarly functioning device.

In one or more embodiments, the grout fluids meet or exceed the geothermal industry standard permeability requirement of 1×10⁻⁷ cm/s when tested using ASTM procedure D5084. For example, the grout fluids may have a permeability of less than 8×10⁻⁸ cm/s. Advantageously, the grout fluids have relatively high thermal conductivities (due to the presence of a thermally conductive material) and low permeabilities (due to optimization of the particle size of the thermally conductive material).

Geothermal Applications The required grout characteristics vary by industry. For example, grouts used in geothermal heat loop installations should have high thermal conductivity characteristics along with the requisite sealing abilities.

Heat transfer loops are often placed in the earth to provide for the heating and cooling of residential and commercial spaces. Since ground temperatures are generally similar to room temperatures in buildings, the use of such heat transfer loops can be cost effective alternatives to conventional heating and cooling systems. The installation of such heat transfer loops involves inserting a continuous loop of pipe connected to a heat pump unit into a hole or series of holes in the earth to act as a heat exchanger. A thermally conductive grout is then placed in the hole between the pipe wall and the earth. A heat transfer fluid can be circulated through the underground heat transfer loop to allow heat to be transferred between the earth and the fluid via conduction through the grout and the pipe wall. When the system is operating in a heating mode, a relatively cool heat transfer fluid is circulated through the heat transfer loop to allow heat to be transferred from the warmer earth into the fluid. Similarly, when the system is operating in a cooling mode, a relatively warm heat transfer fluid is circulated through the heat transfer loop to allow heat to be transferred from the fluid to the cooler earth. Thus, the earth can serve as both a heat supplier and a heat sink. The efficiency of the heat transfer loop is affected by the grout employed to provide a heat exchange pathway and a seal from the surface of the earth down through the hole. The grout needs to have a sufficient thermal conductivity to ensure that heat is readily transferred between the heat transfer fluid and the earth. Further, the grout must form a seal that is substantially impermeable to fluids that could leak into and contaminate ground water penetrated by the hole in which it resides. The permeability, which measures the rate of movement of fluid (i.e., distance/time) through the grout, is thus desirably low. Moreover, the grout needs to have a sufficient viscosity to allow for its placement in the space between the heat transfer loop and the earth without leaving voids that could reduce the heat transfer through the grout while also allowing for the sufficient suspension of thermally conductive materials.

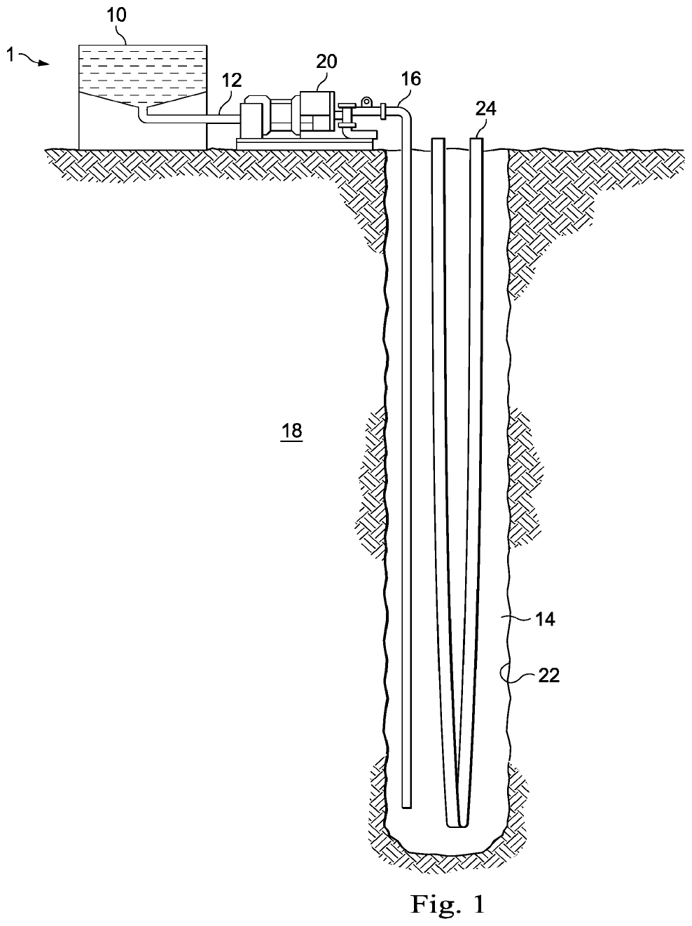

Referring now to FIG. 1, illustrated is a schematic of a system that can deliver the grout fluids of the present disclosure to a downhole location for grouting a geothermal well loop, according to one or more embodiments. As depicted in FIG. 1, system 1 may include mixing tank 10, in which the grout fluids may be formulated. The grout fluids may be conveyed via line 12 to pump 20, and finally to tremie line 16 extending into a wellbore 22 in a subterranean formation 18. As used herein, the term “tremie” refers to a tubular, such as a pipe, through which a grout fluid is placed into a wellbore. The term “tremie” as used herein is not limited to grout fluid placement at a particular water level and use of a tremie to place grout fluid may be performed below or above water level, without departing from the scope of the present disclosure.

A dual piston pump may be used to pump the grout fluid into wellbore 22 through tremie line 16. Alternatively, a piston pump may be used because of its ability to pump materials with a high solids content at higher pressures.

The tremie line 16 extends into an annulus 14 formed between the subterranean formation 18 and a geothermal well loop 24. The geothermal well loop 24 may be a loop with a u-shaped bottom, an S-configuration, an infinity-shaped configuration, or any other configuration capable of forming a continuous tubular for circulating fluid therein to provide cooling and/or heating. The geothermal well loop 24 may be connected to a circulating pump and/or heating and cooling equipment at the surface above the subterranean formation 18.

In use, in one or more embodiments, a grout fluid exits the bottom of the tremie line 16 and the tremie line 16 remains submerged several feet (between about one and three feet) below the level of the grout fluid. As the level of the grout fluid rises in the annulus 14, the tremie line 16 may be withdrawn at approximately the same rate as the final grout fluid is being pumped into the annulus 14 with the pump 20.

While FIG. 1 depicts introducing the grout fluid into an annulus to grout a geothermal well loop in a subterranean formation, other methods may also be employed without departing from the scope of the present disclosure. For example, a displacement method may be utilized where the grout fluid is first introduced into a subterranean formation followed by setting the geothermal well loop therein, which displaces the grout fluid. In other embodiments, an inner-string method of placing the grout fluid may be used where a cementing float shoe is attached to the bottom of a pipe for forming the geothermal well loop before it is sealed and a tremie line is lowered until it engages the shoe, injecting the final grout fluid into the annulus with the tremie line within the pipe. In other embodiments, a casing method of grouting may be utilized where the grout fluid is placed in a pipe for forming the geothermal well loop before it is sealed and the grout fluid is then forced out of the bottom of the pipe and into the annulus. Other methods may also be employed, without departing from the scope of the present disclosure.

In one or more embodiments, methods of installing a conduit in a hole in the earth are provided. In one or more embodiments, the methods include placing the conduit in the hole in the earth, mixing a grout, which may be a one-sack product, with water to form a grout fluid, and placing the grout fluid in the hole adjacent to the conduit. The hole in the earth may be a borehole that has been drilled in the earth to a depth sufficient to hold the conduit therein.

In one or more embodiments, the conduit is a grounding rod used to protect structures such as television towers and radio antennas from lightning strikes. The grounding rod may extend from the top of such structure down to the set grout fluid, which has a relatively low resistivity. As such, if lightning strikes the grounding rod, the current created by the lightning may pass through the grounding rod and the set grout fluid to the ground.

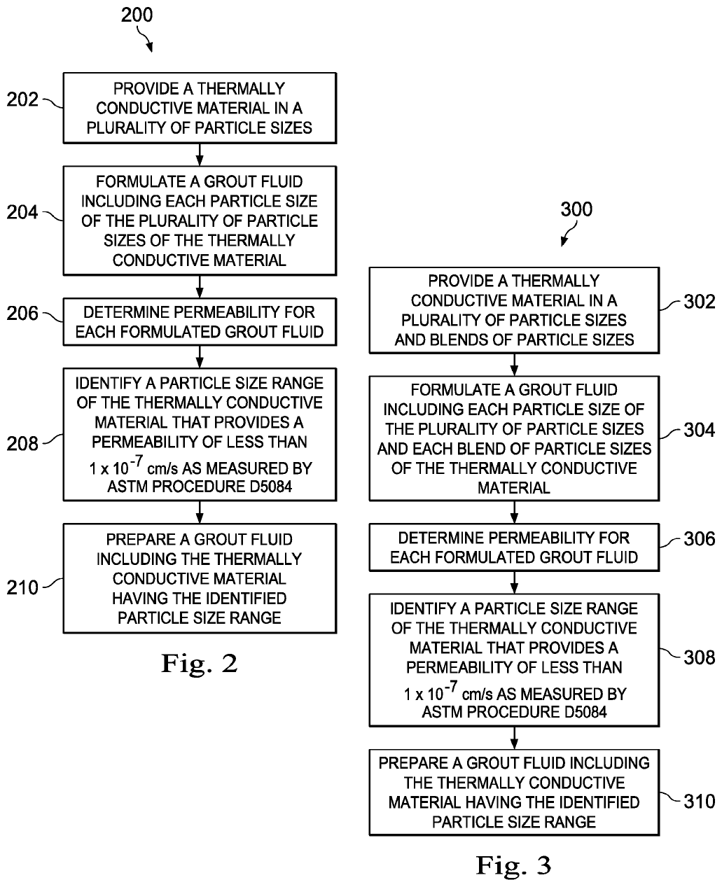

According to one or more embodiments, a method of preparing a grout fluid is provided. Turning now to FIG. 2, the method 200 includes providing a thermally conductive material in a plurality of particle sizes in step 202, formulating a grout fluid including each particle size of the plurality of particle sizes of the thermally conductive material in step 204, determining permeability for each formulated grout fluid in step 206, identifying a particle size range of the thermally conductive material that provides a permeability of less than 1×10⁻⁷ cm/s as measured by ASTM procedure D5084 in step 208, and preparing a grout fluid including the thermally conductive material having the identified particle size range in step 210. As used herein, a “thermally conductive material in a plurality of particle sizes” means that the thermally conductive material includes a plurality of particles, where one or more of the plurality of particles have a particle size that differs from one another. For example, in one or more embodiments, providing a thermally conductive material in a plurality of particle sizes includes providing a thermally conductive material having a particle size of 500 μm, a thermally conductive material having a particle size of 297 μm, a thermally conductive material having a particle size of 177 μm, and a thermally conductive material having a particle size of 149 μm.

According to one or more embodiments, another method of preparing a grout fluid is provided. Turning now to FIG. 3, the method 300 includes providing a thermally conductive material in a plurality of particle sizes and blends of particle sizes in step 302, formulating a grout fluid including each particle size of the plurality of particle sizes and each blend of particle sizes of the thermally conductive material in step 304, determining permeability for each formulated grout fluid in step 306, identifying a particle size range of the thermally conductive material that provides a permeability of less than 1×10⁻⁷ cm/s as measured by ASTM procedure D5084 in step 308, and preparing a grout fluid including the thermally conductive material having the identified particle size range in step 310. As used herein, “blends of particle sizes” means mixtures of particle sizes. For example, in one or more embodiments, a blend or mixture of particle sizes includes a mixture of 6 mesh graphite, 20 mesh graphite, and 50 mesh graphite. The blend would be prepared by mixing the 6 mesh graphite, 20 mesh graphite, and 50 mesh graphite together so that they combine together as a mass.

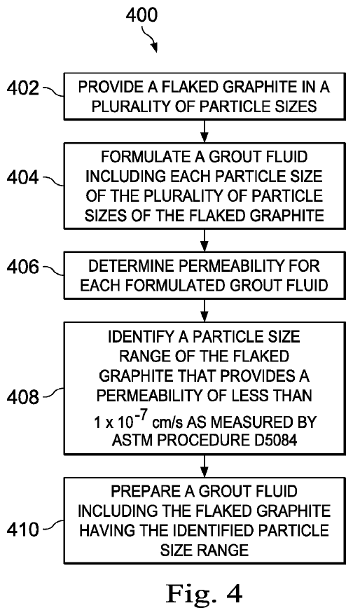

According to one or more embodiments, a method of preparing a grout fluid is provided. Turning now to FIG. 4, the method 400 includes providing a flaked graphite in a plurality of particle sizes in step 402, formulating a grout fluid including each particle size of the plurality of particle sizes of the flaked graphite in step 404, determining permeability for each formulated grout fluid in step 406, identifying a particle size range of the thermally conductive material that provides a permeability of less than 1×10⁻⁷ cm/s as measured by ASTM procedure D5084 in step 408, and preparing a grout fluid including the flaked graphite having the identified particle size range in step 410.

Thus, a method of preparing a grout fluid is provided. Embodiments of the method may generally include providing a thermally conductive material in a plurality of particle sizes, formulating a grout fluid including each particle size of the plurality of particle sizes of the thermally conductive material; determining permeability for each formulated grout fluid; identifying a particle size range of the thermally conductive material that provides a permeability of less than 1×10⁻⁷ cm/s as measured by ASTM procedure D5084; and preparing a grout fluid including the thermally conductive material having the identified particle size range. For any of the foregoing embodiments, the method may include any one of the following, alone or in combination with each other.

In one or more embodiments, the thermally conductive material includes a carbon-based material. In one or more embodiments, the carbon-based material includes graphite.

In one or more embodiments, the method further includes blending two or more particle sizes of the plurality of particle sizes of the thermally conductive material, formulating a grout fluid including a blend of the two or more particle sizes, and determining permeability of the grout fluid including the blend of the two or more particle sizes.

In one more embodiments, a grout fluid prepared according to the above methods is provided. In one or more embodiments, the grout fluid further includes bentonite. In one or more embodiments, the bentonite includes sodium bentonite.

In one or more embodiments, a method of using the grout fluid described above is provided. In one or more embodiments, the method generally includes placing a geothermal conduit in at least one hole in the earth; providing the grout fluid; introducing the grout fluid into a space between the geothermal conduit and sidewalls of at least one hole so that the grout fluid is in contact with the geothermal conduit and the sidewalls; and after introducing the grout fluid, allowing the grout fluid to set to fix the geothermal conduit to at least one hole, wherein after setting, the grout fluid has a permeability at least about 1×10⁻⁷ cm/s as measured by ASTM procedure D5084.

Another method of preparing a grout fluid is also provided. The method includes providing a thermally conductive material in a plurality of particle sizes and blends of particle sizes; formulating a grout fluid including each particle size and each blend of particle sizes of the thermally conductive material; determining permeability for each formulated grout fluid; identifying a particle size range of the thermally conductive material that provides a permeability of less than 1×10⁻⁷ cm/s as measured by ASTM procedure D5084; and preparing a grout fluid including the thermally conductive material having the identified particle size range. For any of the foregoing embodiments, the method may include any one of the following, alone or in combination with each other.

In one or more embodiments, the method includes identifying a blend of particle sizes of the thermally conductive material that has a permeability of less than 1×10⁻⁷ cm/s as measured by ASTM procedure D5084; and preparing a grout fluid including the identified blend of particle sizes of the thermally conductive material. For example, a blend of two or more particle sizes of the thermally conductive material can exhibit a permeability of less than 1×10⁻⁷ cm/s as measured by ASTM procedure D5084, and a grout fluid that includes this blend can be prepared.

In one or more embodiments, the thermally conductive material includes a carbon-based material. In one or more embodiments, the carbon-based material includes graphite.

In one more embodiments, a grout fluid prepared according to the above methods is provided. In one or more embodiments, the grout fluid further includes bentonite. In one or more embodiments, the bentonite includes sodium bentonite.

In one or more embodiments, a method of using the grout fluid described above is provided. The method includes placing a geothermal conduit in at least one hole in the earth; providing the grout fluid; introducing the grout fluid into a space between the geothermal conduit and sidewalls of at least one hole so that the grout fluid is in contact with the geothermal conduit and the sidewalls; and after introducing the grout fluid, allowing the grout fluid to set to fix the geothermal conduit to at least one hole, wherein after setting, the grout fluid has a permeability at least about 1×10⁻⁷ cm/s as measured by ASTM procedure D5084.

A method of preparing a grout fluid is also provided. The method generally includes providing a plurality of particle sizes of a flaked graphite; formulating a grout fluid including each particle size of the plurality of particle sizes of the flaked graphite; determining permeability for each formulated grout fluid; identifying a particle size range of the flaked graphite that provides a permeability of less than 1×10⁻⁷ cm/s as measured by ASTM procedure D5084; and preparing a grout fluid including the flaked graphite having the identified particle size range. For any of the foregoing embodiments, the method may include any one of the following, alone or in combination with each other.

In one or more embodiments, the method further includes blending two or more particle sizes of the plurality of particle sizes of the flaked graphite; formulating a grout fluid including a blend of the two or more particle sizes; and determining permeability of the grout fluid including the blend of the two or more particle sizes.

In one more embodiments, a grout fluid prepared according to the above methods is provided. In one or more embodiments, the grout fluid further includes sodium bentonite.

In one or more embodiments, a method of using the above grout fluid is provided. The method includes placing a geothermal conduit in at least one hole in the earth; providing the grout fluid; introducing the grout fluid into a space between the geothermal conduit and sidewalls of at least one hole so that the grout fluid is in contact with the geothermal conduit and the sidewalls; and after introducing the grout fluid, allowing the grout fluid to set to fix the geothermal conduit to at least one hole, wherein after setting, the grout fluid has a permeability at least about 1×10⁻⁷ cm/s as measured by ASTM procedure D5084.

In one or more embodiments, while different steps, processes, and procedures are described as appearing as distinct acts, one or more of the steps, one or more of the processes, and/or one or more of the procedures may also be performed in different orders, simultaneously and/or sequentially. In one or more embodiments, the steps, processes and/or procedures may be merged into one or more steps, processes and/or procedures. In one or more embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

The following examples are illustrative of the compositions, fluids, and methods discussed above and are not intended to be limiting.

### Example 1

### Effect of Particle Size on Permeability

Commercially available graphite samples were tested at a concentration of 15 lb/bbl in a 25 lb/bbl bentonite-based grout fluid. The graphite sizes tested were 35 mesh, 50 mesh, 80 mesh, and 100 mesh. The correlation between mesh size and micron size is the following:
35 mesh=500 μm
50 mesh=297 μm
80 mesh=177 μm
100 mesh=149 μm

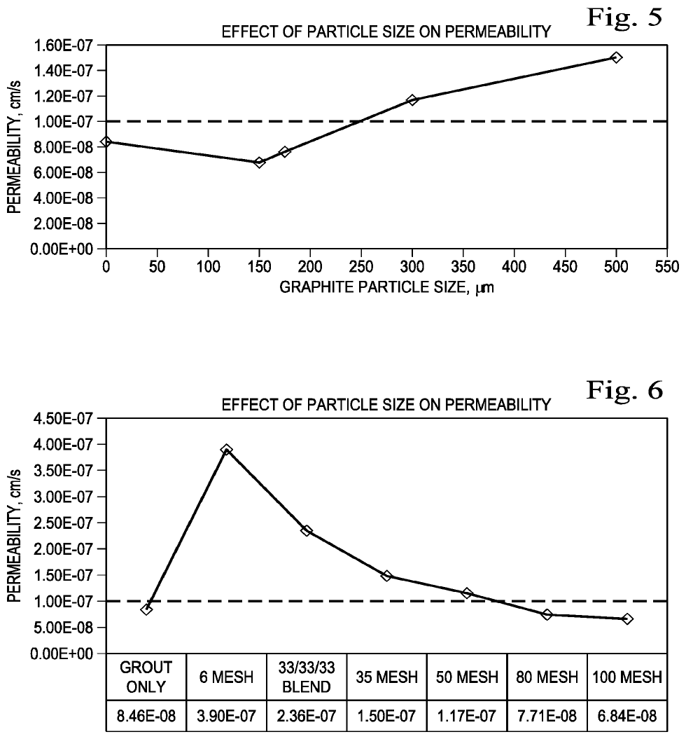

Table 1 below and FIG. 5 provide the permeability results of the graphite in the bentonite-based grout fluid. FIG. 5 shows the target permeability of 1×10⁻⁷ cm/s, and the range of graphite particle sizes that provide desired permeabilities below the target permeability.

TABLE 1
Permeability of Graphite in Grout Fluid

| Sample | Permeability, cm/s |
|---|---|
| Grout Fluid Only | 8.46 × 10⁻⁸ |
| Grout Fluid with 100 mesh Graphite | 6.84 × 10⁻⁸ |
| Grout Fluid with 80 mesh Graphite | 7.71 × 10⁻⁸ |
| Grout Fluid with 50 mesh Graphite | 1.17 × 10⁻⁷ |
| Grout Fluid with 35 mesh Graphite | 1.50 × 10⁻⁷ |

Additionally, laboratory samples were prepared where 6 mesh graphite was segregated for testing. Samples of a blend of 33% 6 mesh graphite, 33% 20 mesh graphite, and 33% 50 mesh graphite were also prepared.

The correlation between mesh size and micron size is the following:
6 mesh=3360 μm
20 mesh=841 μm

Table 2 and FIG. 6 provide the results of these samples. FIG. 6 additionally provides the results from Table 1. FIG. 6 shows the target permeability of 1×10⁻⁷ cm/s, and the range of graphite particle sizes that provide desired permeabilities below the target permeability.

TABLE 2
Permeability of Graphite in Grout Fluid

| Sample | Permeability, cm/s |
|---|---|
| 6 mesh graphite | 3.90 × 10⁻⁷ |
| 33/33/33 blend | 2.36 × 10⁻⁷ |

Permeability was tested using an American Petroleum Institute (API) filter press. Each grout fluid was poured over an API filter press cell, a selected media representative of formation porosity, and allowed to set for 24 hours. Distilled water was then poured onto the filter press cell, the filter press lid was attached, and 10 pounds per square inch (psi) of compressed air was applied. The total filtrate was collected and used to calculate permeability.

The above data demonstrates the impact of particle size on permeability, where the largest particle size resulted in the highest permeability. A blend of smaller particles into the larger particle size, however, aided in lowering the permeability. Conversely, adding larger particles to small particle sizes caused the permeability to increase.

The effect of particle size on permeability, in relation to a target permeability (such as the industry standard of 1×10⁻⁷ cm/s) is directly related and impacted by the permeability of the grout fluid. For example, if the initial permeability of the grout fluid is lower than the ones that were tested above, the entire trend of data is expected to shift downward to low permeability, but to follow the same trend. This will also impact the allowable mesh sizes of graphite for meeting permeability standards. For the grout fluids tested above, the optimal micrometer particle size is less than 245 μm.

Although only a few exemplary embodiments have been described in detail above, those of ordinary skill in the art will readily appreciate that many other modifications are possible in the exemplary embodiments without materially departing from the novel teachings and advantages of the present invention. Accordingly, all such modifications are intended to be included within the scope of the present invention as defined in the following claims.

What is claimed is:

1. A method of preparing a grout fluid comprising:
providing a thermally conductive material in a plurality of particle sizes;
formulating the grout fluid to include each particle size of the plurality of particle sizes of the thermally conductive material;
determining permeability for each formulated grout fluid;
identifying a particle size range of the thermally conductive material that has a permeability of less than 1×10⁻⁷ cm/s as measured by ASTM procedure D5084; and
preparing a grout fluid comprising the thermally conductive material having the identified particle size range.

2. The method of claim 1, wherein the thermally conductive material comprises a carbon-based material.

3. The method of claim 2, wherein the carbon-based material comprises graphite.

4. The method of claim 1, further comprising:
blending two or more particle sizes of the plurality of particle sizes of the thermally conductive material;
formulating a grout fluid including a blend of the two or more particle sizes; and
determining permeability of the grout fluid including the blend of the two or more particle sizes.

5. A grout fluid prepared according to the method of claim 1.

6. The grout fluid of claim 5, further comprising bentonite.

7. The grout fluid of claim 6, wherein the bentonite comprises sodium bentonite.

8. A method of using the grout fluid of claim 5, which comprises:
placing a geothermal conduit in at least one hole in the earth;
providing the grout fluid;
introducing the grout fluid into a space between the geothermal conduit and sidewalls of at least one hole so that the grout fluid is in contact with the geothermal conduit and the sidewalls; and
after introducing the grout fluid, allowing the grout fluid to set to fix the geothermal conduit to at least one hole, wherein after setting, the grout fluid has a permeability at least about 1×10⁻⁷ cm/s as measured by ASTM procedure D5084.

9. A method of preparing a grout fluid, which comprises:
providing a thermally conductive material in a plurality of particle sizes and blends of particle sizes;
formulating a grout fluid including each particle size of the plurality of particle sizes and each blend of particle sizes of the thermally conductive material;
determining permeability for each formulated grout fluid;
identifying a particle size range of the thermally conductive material that has a permeability of less than 1×10⁻⁷ cm/s as measured by ASTM procedure D5084; and
preparing a grout fluid comprising the thermally conductive material having the identified particle size range.

10. The method of claim 9, wherein the thermally conductive material comprises a carbon-based material.

11. The method of claim 10, wherein the carbon-based material comprises graphite.

12. A grout fluid prepared according to the method of claim 9.

13. The grout fluid of claim 12, further comprising bentonite.

14. The grout fluid of claim 13, wherein the bentonite comprises sodium bentonite.

15. A method of using the grout fluid of claim 12, which comprises:
placing a geothermal conduit in at least one hole in the earth;
providing the grout fluid;
introducing the grout fluid into a space between the geothermal conduit and sidewalls of at least one hole so that the grout fluid is in contact with the geothermal conduit and the sidewalls; and
after introducing the grout fluid, allowing the grout fluid to set to fix the geothermal conduit to at least one hole, wherein after setting, the grout fluid has a permeability at least about 1×10⁻⁷ cm/s as measured by ASTM procedure D5084.

16. A method of preparing a grout fluid, which comprises:
providing a flaked graphite in a plurality of particle sizes;
formulating a grout fluid including each particle size of the plurality of particle sizes of the flaked graphite;
determining permeability for each formulated grout fluid;
identifying a particle size range of the flaked graphite that has a permeability of less than 1×10⁻⁷ cm/s as measured by ASTM procedure D5084; and
preparing a grout fluid comprising the flaked graphite having the identified particle size range.

17. The method of claim 16, further comprising:
blending two or more particle sizes of the plurality of particle sizes of the flaked graphite;
formulating a grout fluid including a blend of the two or more particle sizes; and
determining permeability of the grout fluid including the blend of the two or more particle sizes.

18. A grout fluid prepared according to the method of claim 16.

19. The grout fluid of claim 18, further comprising sodium bentonite.

20. A method of using the grout fluid of claim 18, which comprises:
placing a geothermal conduit in at least one hole in the earth;
providing the grout fluid;
introducing the grout fluid into a space between the geothermal conduit and sidewalls of at least one hole so that the grout fluid is in contact with the geothermal conduit and the sidewalls; and
after introducing the grout fluid, allowing the grout fluid to set to fix the geothermal conduit to at least one hole, wherein after setting, the grout fluid has a permeability at least about 1×10⁻⁷ cm/s as measured by ASTM procedure D5084.
